(19) United States
(12) Patent Application Publication
(10) Pub. No.: US 2013/0030946 A1
(43) Pub. Date: Jan. 31, 2013

(54) Creation of Customized Objects for Pet Products Purchased In-Store and/or Online

(71) Applicant: Ulrich Wuebker, Cincinnati, OH (US)

(72) Inventor: Ulrich Wuebker, Cincinnati, OH (US)

(73) Assignee: FLEXI USA, INC., West Chester, OH (US)

(21) Appl. No.: 13/558,551

(22) Filed: Jul. 26, 2012

Related U.S. Application Data
(60) Provisional application No. 61/513,010, filed on Jul. 29, 2011.

(51) Int. Cl. G06Q 30/06

(52) U.S. Cl. 705/26.5

(57) ABSTRACT

A method of providing user customization of a retractable pet leash is provided. The method includes verifying user-provided access code information using a processor that receives the user-provided access code information over the Internet. An image is received from the user after the user-provided access code information is verified using the processor. The image is processed using image processing module according to a specification corresponding to dimensions of the retractable pet leash forming a processed image. A customized object is provided by printing the processed image.

### CROSS-REFERENCE TO RELATED APPLICATIONS

This application claims priority to U.S. Provisional Patent Application Ser. No. 61/513,010, filed Jul. 29, 2011, the details of which are incorporated by reference in their entirety.

### TECHNICAL FIELD

The present application relates to web applications for creating and customizing pet products purchased either in-store or online using customer generated or template content.

### BACKGROUND

Leashes are commonly used in walking or otherwise exercising animals. One such leash is a retractable leash. The housing of this leash accommodates the leash and the roll and features a handle for carrying the leash assembly. A braking device may be provided in order to stop the leash at the desired length. The braking device may also be provided with a locking mechanism for holding the braking device in the stopped state. The desired length of the leash then remains in the stopped state. Such a dog leash enables the dog to move about freely for the most part.

### SUMMARY

In one embodiment, a method of providing user customization of a retractable pet leash is provided. The method includes verifying user-provided access code information using a processor that receives the user-provided access code information over the Internet. An image is received from the user after the user-provided access code information is verified using the processor. The image is processed using an image processing module according to a specification corresponding to dimensions of the retractable pet leash forming a processed image. A customized object is provided by printing the processed image.

In another embodiment, a method of customizing a retractable pet leash is provided. The method includes purchasing a leash product from a pet product seller. The leash product includes access code information. A webpage is accessed prompting entry of the access code information in order to access a web application for creating a customized object. The access code information is provided. A customized object is created using the web application that is sized and configured to be applied to the retractable pet leash.

In another embodiment, a method of providing user customization of a pet leash is provided. The method includes associating access code information with the pet leash. The access code information is provided to the user only after purchase of the pet leash. The user is prompted to provide the access code information using a webpage. The access code information is verified using a processor that receives the access code information over the Internet. Access to a web application for creating a customized object sized and configured to be applied to the pet leash is provided.

The details of one or more embodiments are set forth in the accompanying drawings and the description below. Other features, objects, and advantages will be apparent from the description and drawings.

### BRIEF DESCRIPTION OF THE DRAWINGS

FIG. 1 illustrates an embodiment of a retractable pet leash including a customizable object;

FIG. 2 illustrates an embodiment of a method 40 of customizing a pet product, such as the retractable pet leash of FIG. 1;

FIG. 3 illustrates an embodiment of an exemplary system for generating customized objects; and

FIG. 4 illustrates an embodiment of a webpage used to collect and provide image information to image processing module for creating a customized object.

### DETAILED DESCRIPTION

Embodiments described herein generally relate to the creation of customized objects for pet products, namely retractable leashes. The creation and customization of the objects are facilitated by a web application provided by a customized object provider that allows a user to upload, choose and/or modify objects, created by the user or otherwise, which can be applied to the pet products purchased from a pet product seller, which can add to the visual appeal of the pet products and provide customization of the pet products. Embodiments described herein also allow the user the ability to purchase the pet product, either online or in-store and then create the customized objects, which will be applied to the pet product.

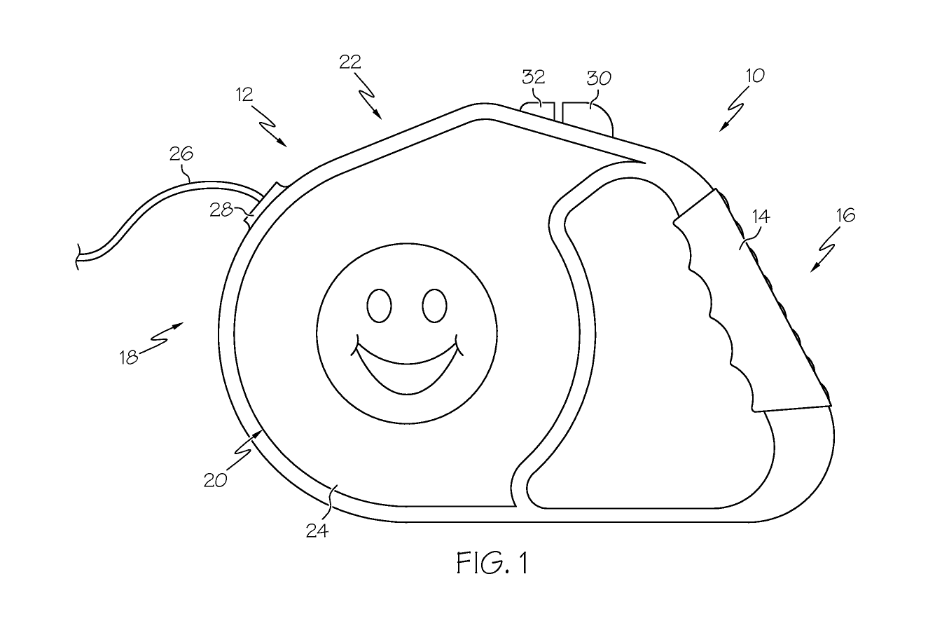

Referring to FIG. 1, a leash assembly 10 includes housing 12 with an integral handle 14 arranged in a rear area of the leash assembly 10. The housing 12 includes the rear area 16, a front area 18 and side areas 20 and 22 on opposite sides of the housing 12. The side area 20 is illustrated as including a customized object 24 applied to the side area 20. Side area 22 may also include the same or a different printed object. As will be described in greater detail below, the printed object can be created and customized by a user using a web application that can be accessed by the user over the internet.

When one wants to walk an animal such as a dog, the leash assembly 10 is connected, normally via a collar, to a leash 26 which extends through an exit opening 28 at the front area 18 of the leash assembly 10. The customized object 24 is sized and dimensioned to allow extension and retraction of the leash 26 and control thereof without any interference therefrom. For example, a brake key 30 and brake locking key 32 may be provided to control the extension and retraction of the leash 26. The customized object 24 may be sized and shaped to avoid any interference with the manual operation of the keys 30 and 32. In the housing 12, the leash 26 is received and stored by a take-up roller device located therein, which is associated with a brake system. Details of an exemplary take-up roller and brake system can be found in U.S. Pat. No. 6,148,773, the details of which are hereby incorporated by reference.

Customizing In-Store Purchases

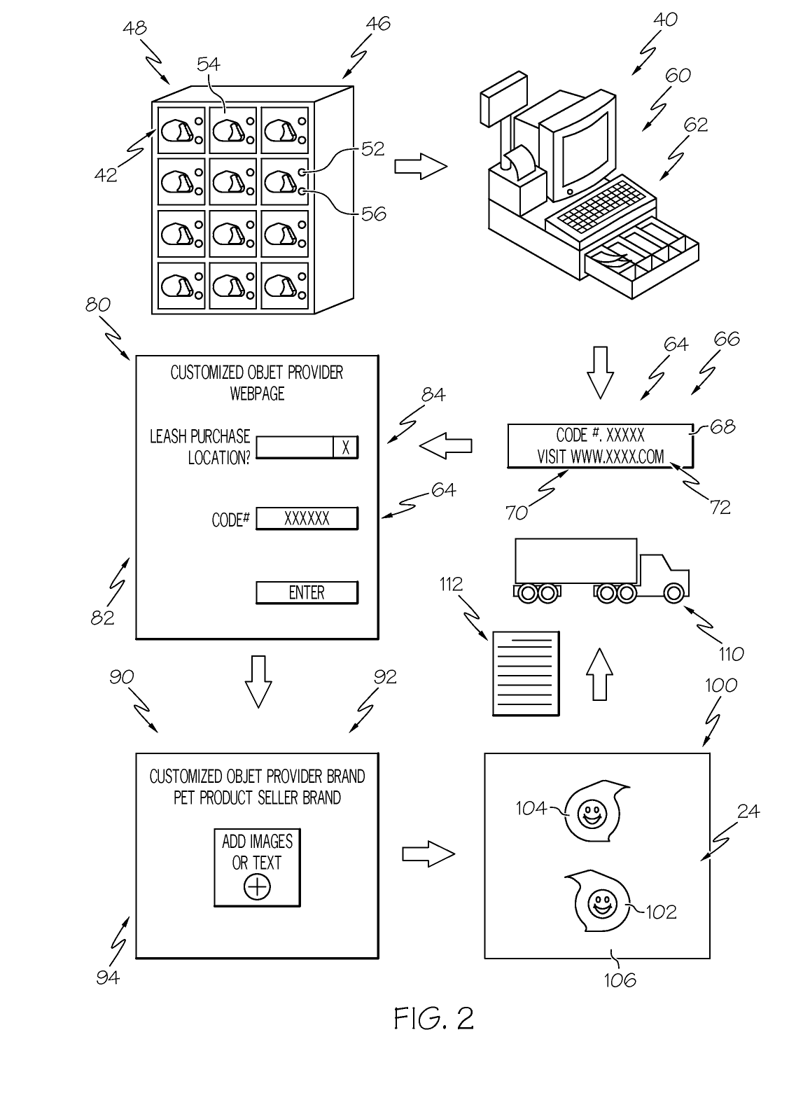

Referring to FIG. 2, a method 40 for customizing a pet product, such as a leash product 42 (e.g., including the leash assembly 10 of FIG. 1) is illustrated. The method 40 includes a user visiting a store 46 of a pet product seller at step 48 where a plurality of leash products 42 is presented for display and purchase. In the illustrated example, the store 46 is a physical location; however, the store 46 may be a virtual store, existing online. The leash products 42 may include leash assemblies 10 (FIG. 1) of varying colors (e.g., red, green, blue, black, white, purple, etc.) and of varying sizes (e.g., small, medium large, x-large, etc.). The leash information or indicia 52 (e.g., color and size) may be printed or shown on a package 54 containing the respective leash assembly 10. The package 54 may also include customization information or indicia 56 that indicates that the leash assembly 10 is customizable as described herein.

A user may choose the desired leash product 42 (e.g., by color and size) at step 48 and proceed to a check-out step 60 at a point-of-sale location 62. At the check-out step 60, the user may purchase the leash product 42. The purchase price of the leash product 42 may include the purchase price for creating, customizing and printing the printed object 24.

Access code information 64 may be provided as part of the leash product 42 at step 66. It may be the case that the leash manufacturer, the pet product seller and the customized object provider are not the same entity. In these embodiments, the access code information 64 may be provided from the customized object provider to one or both of the pet product seller and the leash manufacturer such that the access code information 64 is available for the user upon purchase of the leash product 42 (e.g., in or on the package 54 or provided at the point-of-sale location 62). Alternatively, the access code information 64 may be generated by the pet product seller or the leash manufacturer and then provided to the customized object provider before and/or after the leash product 42 is purchased. The access code information 64 may be provided, for example, on the package 54 (e.g., on the interior or exterior thereof) or inside or outside the package 54, for example, on a separate card or sheet, such as a separate instruction sheet 68. The instruction sheet 68 may further include instructions 70 for customizing the leash assembly 10 as well as website information 72 that directs the user to a particular website where generation of the customized object 24 can be carried out.

At step 80, the user may visit a website 82 that is identified using the website information 72. The website 82 may be provided by the customized object provider and may provide a security gateway that requires entry of the access code information 64 from the instruction sheet 68 before accessing the web application. In some embodiments, the website 82 may request entry of store purchase information 84. The store purchase information 84 can be used in identifying and recording the purchase location.

At step 90, upon entry of acceptable access code information 64 and store purchase information 84, the user may access the web application 92. An exemplary webpage 94 is illustrated where the user can upload images and/or add text for creating the customized object 24. The store purchase information 84 may be used to co-brand the webpage 94 to associate the web application and the customization experience with the pet product seller, which may or may not be more familiar to the user than the customized object provider. Once the user has designed the customized object 24, the user may choose to provide digital copies of the customized object 24 to others for viewing, such as through various social networks, such as Facebook®, Pinterest®, etc. Tools may be provided through the web application for interacting with the social networks.

At step 100, the customized object 24 may be generated. The customized object 24, for example, may be printed as a sticker 102 and 104 on a release paper 106 by the customized object provider. The customized objects 24 may be any of stickers, decals, non-adhesive images, skins, etc. At step 110, the customized object 24 is then shipped or otherwise delivered to the customer for application to the leash assembly 10. Instructions 112 may be provided for applying the customized object 24 to the leash assembly 10 along with proper care instructions.

Customizing Online Purchases

Users may choose to purchase the leash products 42 online, as opposed to visiting a physical retail pet store. Where the pet product seller and the customized object provider are not the same, the method of customizing the leash assembly 10 may be similar to that described above where the selected leash product 42 is shipped from the pet product seller to the user with the instruction sheet 68 including the access code information 64. Where the pet product seller and the customized object provider are the same, the selection of the leash product 42 may be similar to that described above, along with the creation of the customized object 24. In these embodiments, however, the customized object 24 may be shipped with the leash product 42 to the user along with instructions on applying the customized object 24 to the leash assembly 10 or the customized object 24 may be applied by the customized object provider to the leash assembly 10 prior to shipping. For example, a printer may be used by the customized object provider to print the customized object 24 directly onto the housing 12 and then shipped to the user. In other embodiments, the customized object 24 may be printed (e.g., as a sticker) and applied by the customized object provider prior to shipping the leash product 42 to the user.

System for Generating Customized Objects

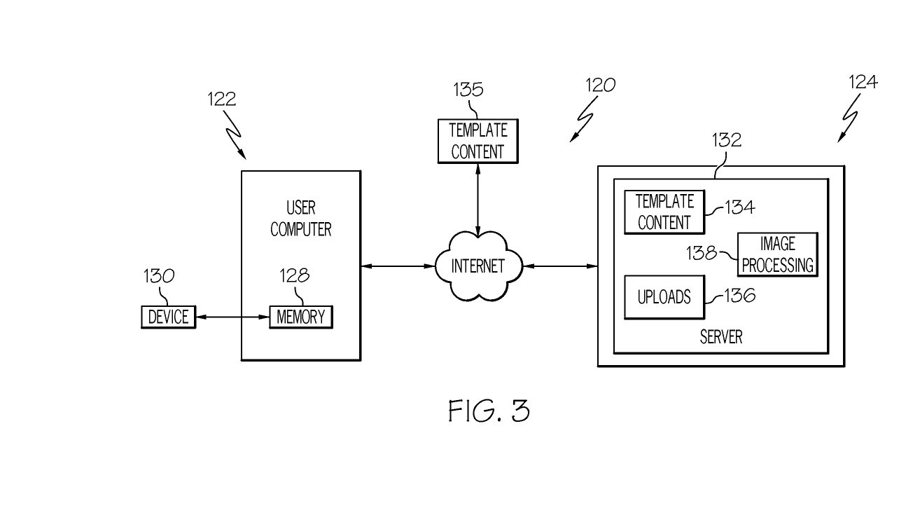

Referring to FIG. 3, an exemplary system 120 for generating customized objects 24 includes a user computer 122 that is capable of communicating with a server 124 over the Internet 126. As used herein, computers and servers may include a computer consists of at least one processing element and some form of memory. The processors may utilize various types digital and graphics processing devices including, without limitation, digital signal processors (DSPs), reduced instruction set computers (RISC), general-purpose (CISC) processors, microprocessors, gate arrays (e.g., FPGAs), programmable logic devices (PLDs), reconfigurable compute fabrics (RCFs), array processors, and application-specific integrated circuits (ASICs). The user computer 122 includes memory 128 that stores a plurality of images, such as photographs, drawings or other artwork, maps, graphs, etc. In some embodiments, the photographs, drawings or other artwork, maps, graphs, etc. are created by the user, for example, using a device 130, such as a camera, cell phone, scanner, etc. In other embodiments, the images may be created using the computer or otherwise saved in the memory 128. The server 124 includes memory 132 that stores template content 134 (i.e., content generated or otherwise provided by the server 124), uploaded information 136 (e.g., uploaded from the user computer 122) and an image processing module 138. As used herein, a “module” refers to any type of software, firmware or combinations thereof that perform a desired function. Template content 135 may also be provided from external devices or databases (e.g., through cloud computing).

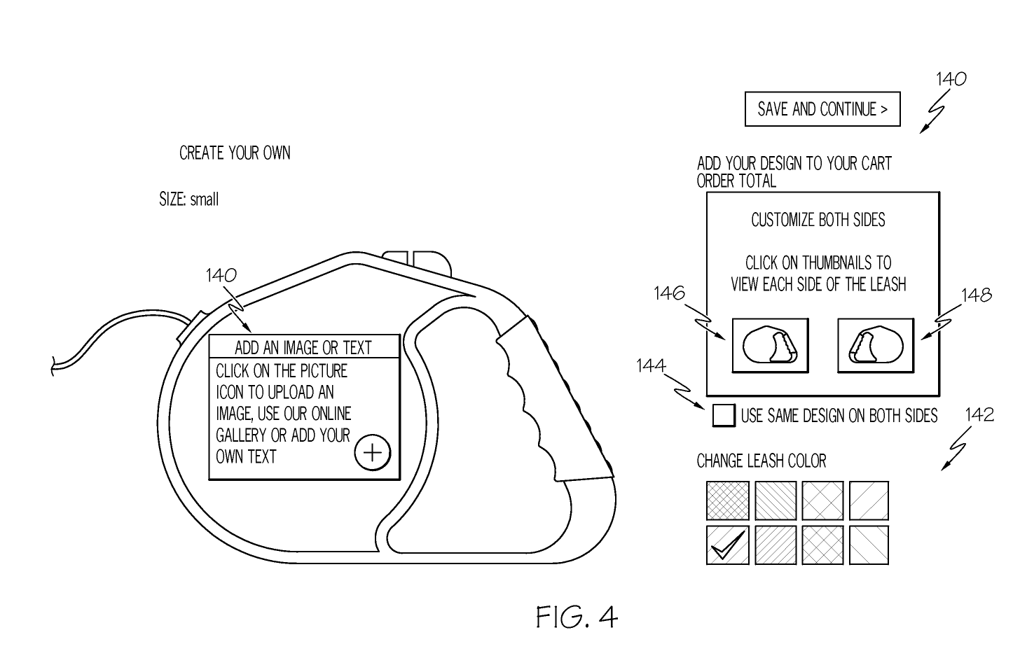

Referring to FIG. 4, the server 124 (or a different server) may provide a website or other interface that facilitates the creation of the customized objects 24. FIG. 4 illustrates a webpage 140 that is used to collect and provide image information to the image processing module 138. In the illustrated embodiment, a button 140 or other user selectable item is provided that allows a user to browse for an image file in the memory 128 of the user computer 122. Selectable leash color templates 142 are also provided that allow a user to select a leash color. In some embodiments, mousing over ones of the leash color templates 142 cause the leash color to change on the webpage 140. For example, the leash color templates may be available on the template content 135 provided from an external database. Button 144 allows use of the same image for both side areas 20 and 22 (FIG. 1). Alternatively, different images may be selected for each side area 20 and 22. Once the image(s) have been selected, the image processing module formats the images to a preselected size and dimension to fit the leash assembly 10. Both sides of the leash assembly 10 with image can be viewed by selecting buttons 146 and 148.

The above-described systems and methods allow user to customize products bought online or in-store. The customized objects can be specifically tailored to fit on a retractable leash without interfering with any of the control features of the retractable leash. Customized objects can be provided that are sized to fit retractable leashes of different sizes. The customized objects may be formed of materials that facilitate removal and replacement of the customized objects without any damage to the customized objects. Further, a web application can be provided to the users over the Internet that facilitates use of custom images in developing the customized objects. Users can purchase the customized objects when purchasing the products, without any need for additional purchases.

It is to be clearly understood that the above description is intended by way of illustration and example only and is not intended to be taken by way of limitation, and that changes and modifications are possible.

What is claimed is:

1. A method of providing user customization of a retractable pet leash, the method comprising:
verifying user-provided access code information using a processor that receives the user-provided access code information over the Internet;
receiving an image from the user after the user-provided access code information is verified using the processor;
processing the image using an image processing module according to a specification corresponding to dimensions of the retractable pet leash forming a processed image; and
providing a customized object by printing the processed image.

2. The method of claim 1 further comprising sending the customized object to the user.

3. The method of claim 1 comprising printing the processed image directly onto a housing of the retractable leash.

4. The method of claim 1 further comprising sending the retractable leash to the user along with the customized object.

5. The method of claim 1 further comprising receiving image processing input from the user, wherein the step of processing the image includes processing the image according to the image processing input.

6. The method of claim 1 further comprising prompting the user to provide the image using a webpage accessible over the Internet.

7. The method of claim 6 further comprising determining a pet product seller based on purchase information received from the user.

8. The method of claim 7 further comprising providing a co-branding indicia associated with the pet product seller.

9. The method of claim 8, wherein the step of providing the customized object is performed by a customizable object provider, the customizable object provider being different from the pet product seller.

10. The method of claim 9, wherein the webpage is provided by the customizable object provider.

11. A method of customizing a retractable pet leash, the method comprising:
purchasing a leash product from a pet product seller, the leash product including access code information;
accessing a webpage prompting entry of the access code information in order to access a web application for creating a customized object;
entering the access code information at the website; and
creating a customized object using the web application that is sized and configured to be applied to the retractable pet leash.

12. The method of claim 11 further comprising providing an image to the web application.

13. The method of claim 11 further comprising selecting a size of the retractable pet leash.

14. The method of claim 11 further comprising selecting the leash product from a display within a retail store.

15. A method of providing user customization of a pet leash, the method comprising:
associating access code information with the pet leash, the access code information being provided to the user only after purchase of the pet leash;
prompting the user to provide the access code information using a webpage;
verifying access code information using a processor that receives the access code information over the Internet; and
providing access to a web application for creating a customized object sized and configured to be applied to the pet leash.

16. The method of claim 15 further comprising receiving an image from the user after the access code information is verified using the processor.

17. The method of claim 15 further comprising processing the image using image processing module according to a specification corresponding to dimensions of the retractable pet leash forming a processed image.

18. The method of claim 15 further comprising providing the customized object by printing the processed image.

19. The method of claim 18 further comprising determining a pet product seller based on purchase information received from the user.

20. The method of claim 15 further comprising printing the customized object directly onto a housing of the retractable leash.
